(19) United States
(12) Patent Application Publication
(10) Pub. No.: US 2005/0063285 A1
(43) Pub. Date: Mar. 24, 2005

(54) Optical disc drive and optical pickup

(75) Inventors: Yoshihiro Mushika, Osaka (JP); Osamu Kajino, Osaka (JP)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: Matsushita Electric Industrial Co., Ltd.

(21) Appl. No.: 10/947,991

(22) Filed: Sep. 23, 2004

(30) Foreign Application Priority Data
Sep. 24, 2003 (JP) 2003-332209

(51) Int. Cl. G11B 7/00

(52) U.S. Cl. 369/112.29; 369/112.01

(57) ABSTRACT

An apparatus for reading and/or writing data from/on a medium with a light beam includes: a light source for generating the light beam; an objective lens for focusing the beam onto the medium; a lens shift sensor for sensing how much the optical axis of the objective lens has shifted from that of the beam; a wavefront corrector, in which correcting elements are arranged as a two-dimensional array so as to locally correct the wavefront of the beam and to be driven independently of each other; a wavefront calculator for finding correlation between each coordinate on a cross section of the beam and the wavefront phase of the beam; a lens shift correction calculator for modifying the coordinate-wavefront phase correlation according to the output of the lens shift sensor; and a controller for controlling the wavefront corrector in accordance with the output of the lens shift correction calculator.

### BACKGROUND OF THE INVENTION

1. Field of the Invention

The present invention generally relates to an apparatus for optically reading and/or writing information (or data) from/on a given medium, and more particularly relates to an optical disc drive and an optical pickup each including a wavefront corrector for controlling the wavefront of a light beam.

2. Description of the Related Art

Generally speaking, in an apparatus such as an optical disc drive for reading and/or writing information optically from/on a storage medium (e.g., an optical disc), a wavefront corrector such as a liquid crystal element or a deformable mirror is often provided along the optical path of an incoming light beam in order to compensate for aberrations caused by variations in the tilt and base material thickness (i.e., the depth of the data storage layer) of the optical disc. In this case, it is important to minimize the decrease in aberration correction ability due to the shift of the optical axis of an objective lens from that of the light beam (which will be referred to herein as a “lens shift”).

In the optical disc drive, the objective lens is normally built in an optical pickup so as to focus a laser beam, emitted from a light source provided in the same optical pickup, onto the data storage layer of the given optical disc and form a beam spot there.

Also, the optical disc drive usually carries out a tracking control operation such that the beam spot of the laser beam exactly follows the target track on the optical disc. This tracking control operation is carried out by getting the objective lens in the optical pickup driven by an actuator in such a manner as to minimize the deviation of the beam spot from the target track on the optical disc.

When the objective lens moves parallel to the data storage layer of the optical disc and perpendicularly to the track as a result of the tracking control operation, a lens shift is produced. Then, the wavefront correction for compensating for the aberrations cannot be achieved appropriately.

One method for reducing the bad effects of the lens shift is to combine the wavefront corrector and the objective lens together. In that case, the optical axis of the objective lens is always aligned with the center of the wavefront correction pattern, thus minimizing the decrease in the aberration correction ability. Nevertheless, the response characteristic should decrease due to the increase in the weight of the movable part, the actuator should have a complicated structure so as to get connected to the wavefront corrector appropriately, the optical pickup of that type should have an increased thickness, and various other secondary problems should arise. The more necessary it is to make the wavefront corrector realize high-precision correction, process a multi-segment wavefront correction pattern and work in multiple different aberration modes properly, the more difficult it is to minimize the unwanted decrease in aberration correction ability while avoiding all those problems at the same time.

For these reasons, a number of alternative arrangements, in which the wavefront corrector is not provided on the objective lens but on the base of the optical pickup, were proposed to minimize the bad effects of the lens shift with all of those problems avoided. For example, in Japanese Laid-Open Publication No. 11-96577, a parallel plate is inserted between the wavefront corrector and the objective lens and is tilted according to the degree of the lens shift. Japanese Laid-Open Publication No. 11-96577 also discloses another alternative arrangement in which either the light source or the photodetector is moved according to the degree of the lens shift.

On the other hand, Japanese Laid-Open Publication No. 2001-167470 discloses that the wavefront corrector should have not only a first group of electrodes for use when there is no lens shift but also second and third groups of electrodes provided in case of external and internal lens shifts, respectively, and should selectively use those three groups of electrodes depending on whether the lens shift exceeds a predetermined degree or not. Specifically, Japanese Laid-Open Publication No. 2001-167470 discloses a working example in which a first group of electrodes provided for liquid crystal elements to correct the tilt of the optical disc substrate is combined with second and third groups of electrodes. In another working example disclosed by Japanese Laid-Open Publication No. 2001-167470, a first group of electrodes provided for liquid crystal elements to correct the spherical aberration is combined with second and third groups of electrodes.

These conventional arrangements, however, have the following drawbacks.

Firstly, the lens shift correcting mechanism disclosed in Japanese Laid-Open Publication No. 11-96577 tends to increase the overall size and cost of the drive unintentionally. The reason is that this arrangement needs additional members such as the parallel plate and a driving portion for tilting that plate in order to correct the lens shift. Also, to correct the lens shift sufficiently accurately, a control mechanism for synchronizing the operations of these mechanisms with the movement of the objective lens timely enough is needed. Thus, the addition of such a lens shift correcting mechanism must complicate the overall drive excessively.

Secondly, in the arrangement using the second and third groups of electrodes as disclosed in Japanese Laid-Open Publication No. 2001-167470, the resultant wavefront correction accuracy and the number of types of correctible wavefronts are not enough. Specifically, the first group of electrodes cannot be provided where the second or third group of electrodes is already provided. Thus, a tradeoff is inevitable between a preferred arrangement of groups of electrodes to increase the wavefront correction accuracy and a preferred arrangement of groups of electrodes to minimize the unwanted effects of the lens shift. In other words, it is difficult to cope with a wide range of lens shifts while maintaining sufficient wavefront correction accuracy. Furthermore, according to the technique of Japanese Laid-Open Publication No. 2001-167470, an electrode pattern for reducing the effects of the lens shift with the tilt corrected should be designed separately from an electrode pattern for reducing the effects of the lens shift with the spherical aberration corrected. However, some drives need to deal with a composite aberration of the tilt-induced aberration and spherical aberration or any other aberration in general. Consequently, according to the technique of Japanese Laid-Open Publication No. 2001-167470, it is still difficult to reduce the lens shift effects sufficiently while coping with any of those various other aberrations flexibly enough.

Thirdly, the arrangement disclosed in Japanese Laid-Open Publication No. 2001-167470 cannot perform the wavefront correction precisely enough with respect to a very small lens shift. Specifically, in Japanese Laid-Open Publication No. 2001-167470, no corrections are made on a lens shift of less than 200 μm and just one step of correction is done on a lens shift of 200 μm or more. In this manner, the arrangement disclosed in Japanese Laid-Open Publication No. 2001-167470 just decides whether or not the correction is needed and cannot cope with a micro lens shift precisely enough.

### SUMMARY OF THE INVENTION

In order to overcome the problems described above, preferred embodiments of the present invention provide an optical disc drive and an optical pickup that can make the wavefront correction precisely enough with the lens shift effects minimized and without using any special member for aligning the optical axes of the objective lens and light beam with each other.

An apparatus according to a preferred embodiment of the present invention is used for reading and/or writing data from/on a medium with a light beam. The apparatus preferably includes: a light source for generating the light beam; an objective lens for focusing the light beam onto the medium; lens shift sensing means for sensing how much the optical axis of the objective lens has shifted from that of the light beam; wavefront correcting means, in which a plurality of correcting elements are arranged as a two-dimensional array so as to locally correct the wavefront of the light beam and to be driven independently of each other; wavefront calculating means for finding correlation between each coordinate on a cross section of the light beam and the wavefront phase of the light beam; lens shift correction calculating means for modifying the coordinate-wavefront phase correlation according to the output of the lens shift sensing means; and control means for controlling the wavefront correcting means in accordance with the output of the lens shift correction calculating means.

In one preferred embodiment of the present invention, the apparatus may further include a wavefront sensor for sensing the wavefront of the light beam. In that case, the wavefront calculating means preferably finds the correlation between each said coordinate on the cross section of the light beam and the wavefront phase of the light beam in accordance with the output of the wavefront sensor.

In an alternative preferred embodiment, the apparatus may further include means for sensing the tilt of the medium with respect to the light beam. In that case, the wavefront calculating means preferably finds the correlation between each said coordinate on the cross section of the light beam and the wavefront phase of the light beam in accordance with the tilt of the medium with respect to the light beam.

In another alternative preferred embodiment, the apparatus may further include means for sensing the spherical aberration on the medium. In that case, the wavefront calculating means preferably finds the correlation between each said coordinate on the cross section of the light beam and the wavefront phase of the light beam in accordance with the spherical aberration.

In still another preferred embodiment, the lens shift correction calculating means preferably modifies the coordinate-wavefront phase correlation by shifting the coordinate of the light beam in a direction in which the optical axis of the objective lens has shifted from that of the light beam.

In this particular preferred embodiment, supposing the correcting elements are arranged at a pitch p in the direction in which the optical axis of the objective lens has shifted from that of the light beam, the lens shift correction calculating means preferably shifts the coordinate of the light beam even if the shift of the optical axis is smaller than the pitch p.

In yet another preferred embodiment, the wavefront calculating means preferably calculates an overall aberration as a composite of a first aberration mode, associated with a variation in the base material thickness of the medium, and a second aberration mode associated with the tilt of the medium.

In a specific preferred embodiment, the first aberration mode may include a term of the sixth or higher order within itself with respect to a distance r from the center of the optical axis.

In another specific preferred embodiment, the second aberration mode may include a term of the fifth or higher order within itself with respect to a distance r from the center of the optical axis.

In yet another preferred embodiment, each said correcting element of the wavefront correcting means preferably includes a micro reflective mirror that reflects the light beam, and the wavefront correcting means preferably functions as a deformable mirror.

In yet another preferred embodiment, the wavefront correcting means may include liquid crystal elements, and each said correcting element of the wavefront correcting means may have a liquid crystal region for optically modulating the light beam.

An optical pickup according to a preferred embodiment of the present invention preferably includes: a base; a light source, which is provided on the base so as to emit a light beam; an objective lens, which is provided on the base in rotatable position so as to focus the light beam onto a medium; an objective lens actuator, which is able to move the objective lens perpendicularly to the optical axis of the light beam; and wavefront correcting means, which is provided on the base such that a plurality of correcting elements, each correcting the wavefront of the light beam locally, are arranged as a two-dimensional array, and which defines a spatial wavefront correction pattern by controlling these correcting elements independently of each other. The optical pickup preferably shifts the wavefront correction pattern, defined by the wavefront correcting means, in a direction in which the optical axis of the objective lens has shifted from that of the light beam.

According to various preferred embodiments of the present invention described above, the wavefront calculating means finds correlation between each coordinate of the light beam and the wavefront phase and the lens shift correction calculating means modifies the coordinate-wavefront phase correlation according to the magnitude of lens shift. And the wavefront correction control means controls the wavefront correcting means in accordance with the output of the lens shift correction calculating means. Thus, the wavefront can be corrected highly precisely without using any special member for lens shift correction.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 schematically illustrates a configuration for an optical disc drive according to a first specific preferred embodiment of the present invention.

FIG. 2 is an exploded perspective view of the deformable mirror shown in FIG. 1.

FIGS. 3A, 3B and 3C show one-dimensional relationships between the drive points of the deformable mirror and the wavefront approximation accuracy.

FIGS. 4A and 4B show two-dimensional relationships between the drive points of the deformable mirror and the wavefront approximation accuracy.

FIGS. 5A and 5B are plan views illustrating the photosensitive areas of the photodetector shown in FIG. 1.

FIG. 6 shows a schematic configuration for the detector circuit of the photodetector shown in FIG. 1.

FIGS. 7A and 7B show corrected wavefront shapes of the deformable mirror in a situation where a lens shift has occurred.

FIG. 8 schematically illustrates a configuration for an optical disc drive according to a second specific preferred embodiment of the present invention.

FIG. 9 schematically illustrates how a wavefront correction pattern shifts as the optical axis of the objective lens 6 shifts.

FIG. 10 schematically illustrates a configuration for an optical disc drive according to a third specific preferred embodiment of the present invention.

FIG. 11 is a flowchart showing how the optical disc drive of the third preferred embodiment operates.

### DETAILED DESCRIPTION OF PREFERRED EMBODIMENTS

### Embodiment 1

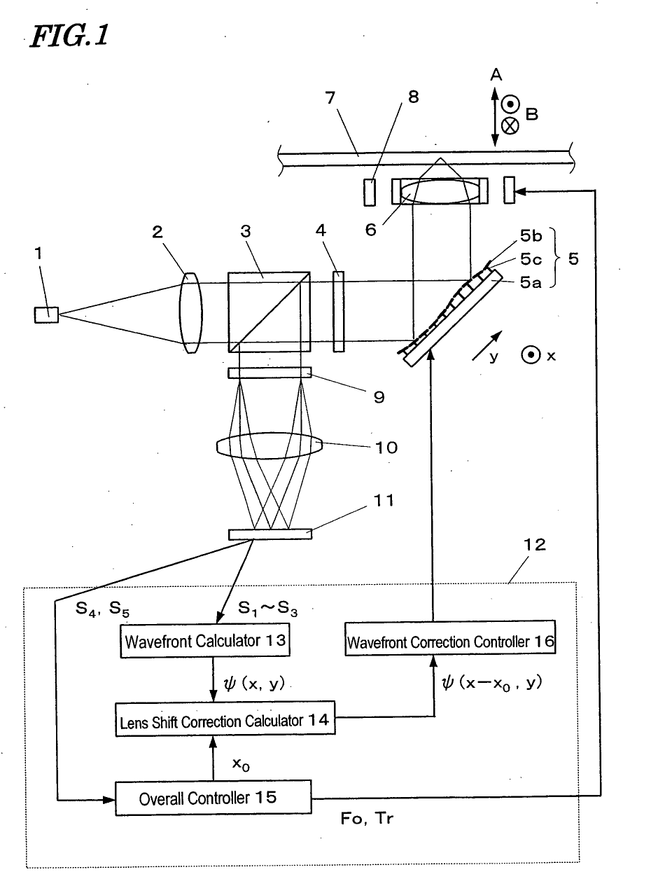

Hereinafter, an apparatus according to a first specific preferred embodiment of the present invention will be described with reference to FIGS. 1 through 7. In the following preferred embodiment, the apparatus is implemented as an optical disc drive.

First, referring to FIG. 1, illustrated is a schematic configuration for an optical disc drive according to this first preferred embodiment. This optical disc drive is an apparatus for reading and/or writing data from/on a given medium (i.e., an optical disc in this case).

A light beam emitted from a light source 1 such as a GaN laser diode is transformed by a collimator lens 2 into an parallel light beam, which is then incident onto a polarization beam splitter 3. Only the P-polarized component of this light beam is transmitted through the polarization beam splitter 3, while the remaining S-polarized component is reflected from the polarization beam splitter 3 so as to enter a front light monitor (not shown). Thereafter, the transmitted P-polarized component is transformed by a quarter-wave plate 4 into circularly polarized light.

A deformable mirror 5 for use in this preferred embodiment is a mirror obtained by arranging a great many displaceable micromirrors 5b on a substrate 5a. Such a deformable mirror 5 may have the configuration disclosed by the applicant of the present application in the pamphlet of PCT International Application Publication No. WO 02/061488 (filed on Jan. 29, 2002) and in the pamphlet of PCT International Application Publication No. WO 03/065103 (filed on Nov. 26, 2002). The application according to the pamphlet of PCT International Application Publication No. WO 02/061488 entered the US national phase on Jul. 29, 2003 (application Ser. No. 10/470,685) and the application according to the pamphlet of PCT International Application Publication No. WO 03/065103 entered the US national phase on Jul. 23, 2004. The entire contents of these two U.S. patent applications are hereby incorporated by reference.

Those micromirrors 5b are arranged as a two-dimensional array so as to define one reflective surface altogether. Each of the micromirrors 5b is driven by a driving portion 5c that is connected to the back surface thereof. The displacement of each micromirror 5b perpendicular to the substrate 5a and/or the tilt of the micromirror 5b with respect to the substrate 5a can be controlled independently. The important function of the deformable mirror 5 of this preferred embodiment is that each micromirror 5b can not only be tilted with respect to the substrate 5a but also be displaced entirely from the substrate 5a while being either tilted or parallel to the substrate 5a. Since the micromirror 5b can be tilted and displaced in this manner, the wavefront phase can be corrected with sufficiently high precision.

By displacing those micromirrors 5b, the wavefront of the light beam can be changed locally. Thus, each micromirror 5b and its associated driving portion 5c together functions as a correcting element, which is the minimum unit of wavefront correction. The angle at which the incoming light is incident on the deformable mirror 5 and the angle at which the light is reflected away from the deformable mirror 5 may be both set to 45 degrees, for example. The detailed structure of the deformable mirror 5 will be described later.

After having its phase converted by the deformable mirror 5, the light beam is focused by an objective lens 6 onto a data storage layer of a given optical disc 7. The objective lens 6 is driven by an objective lens actuator 8 in a direction A parallel to the optical axis of the light beam and in a direction B perpendicular to the optical axis of the light beam. That is to say, the objective lens 6 is designed so as to focus the light beam on any desired data storage layer of the optical disc 7 and make the beam spot follow any desired track on the optical disc 7. The direction B that is perpendicular to the optical axis of the light beam is the radial direction of the optical disc 7 and the direction coming out of the paper of FIG. 1.

The optical disc 7 is an optical storage medium including a plurality of data storage layers, which are stacked one upon the other at a rectangular interval, and a translucent base member provided as a protective coating for the data storage layers. The optical disc 7 is supposed to be tracked by a sample servo method and pre-pits are formed in a hound's-tooth check pattern in the servo area of each of the data storage layers. The light beam that has been reflected from one of the data storage layers of the optical disc 7 is transmitted through the deformable mirror 5 and the quarter-wave plate 4 again. This light beam consists mostly of the S-polarized component, and therefore, reflected by the polarization beam splitter 3 so as to have its wavefront sensed by a wavefront sensor including a hologram 9, a lens 10 and a photodetector 11. This wavefront sensor is a modal type, which may be designed by a known technique such as that disclosed by M. A. A. Neil, M. J. Booth and T. Wilson in “New Modal Wave-Front Sensor: a Theoretical Analysis”, J. Opt. Soc. Am. A, Vol. 17, No. 6, pp. 1098-1107 (2000), for example.

The hologram 9 produces ±first-order light beams in mutually different directions for a number n (where n is an integer that is equal to or greater than two) of orthogonal aberration modes Mi (where i=1 through n). The plus and minus first-order light beams associated with each aberration mode Mi are given bias aberrations of +BiMi and −BiMi, respectively, where Bi is a predetermined bias coefficient. The hologram 9 is either a multi-stage binary hologram with an approximately sine wave cross section or a blaze-shaped hologram with an equilateral triangular cross section, and is designed so as to increase the diffraction efficiency by reducing the percentages of high-order light beams other than the ±first-order light beams. Also, the depth of the diffraction grooves is set to an appropriate value so that the zero-order light beam is transmitted at a predetermined ratio.

The n pairs of light beams, which have been deviated by the hologram 9, are then focused by the lens 10 onto the photodetector 11. Supposing the lens 10 has a focal length f, each of the hologram 9 and the photodetector 11 is spaced apart from the principal plane of the lens 10 by the distance f. The lens 1 functions as a Fourier transform lens.

The photodetector 11 generates a differential output Si between intensity signals representing the ±first-order light beams of each of the n pairs. The differential output Si associated with each aberration mode Mi is a signal representing the magnitude Ai of that aberration mode Mi. The sensitivity Si/Ai with respect to the aberration mode Mi is determined in advance by the bias coefficient Bi and other design parameters.

As a basis function for the orthogonal aberration modes, a basis function Zi of Zernike polynomials may be used. In this preferred embodiment, however, M1, M2 and M3 given by the following Equations (1), (2) and (3) are selected as basis functions representing the aberrations caused by the variation in the base material thickness of the optical disc 7 and by the tilt of the optical disc 7 more directly. As for another aberration M4 caused by the defocusing of the objective lens 6, a defocusing basis function Z2 of normal Zernike polynomials is used as represented by the following Equation (4):
M1=1.78−8.75 r²+4.50 r⁴+2.49 r⁶+1.27 r⁸+0.67 r¹⁰+0.37 r¹² (1)
M2=(4.47 r−4.60 r³−1.78 r⁵−0.75 r⁷−0.34 r⁹)cos θ (2)
M3=(4.47 r−4.60 r³−1.78 r⁵−0.75 r⁷−0.34 r⁹)sin θ (3)
M4=Z2=\sqrt{3} (2 r²−1) (4)
where M1 is a spherical aberration mode associated with a variation in the base material thickness of the optical disc 7, M2 is an aberration mode associated with the tilt of the optical disc 7 in the radial direction and M3 is an aberration mode associated with the tilt of the optical disc 7 in the tangential direction. These aberration modes are substantially orthogonal to each other and have a norm of approximately one. It should be noted that (r, θ) is polar coordinates on the plane of the hologram 9 and r is a radius that has been normalized as 0≦r≦1.

As can be seen from the following Equation (5), the basis function Z11 of Zernike polynomials on the first-order spherical aberration includes terms of the fourth or lower orders of the radius r. Also, as can be seen from the following Equations (6) and (7), the basis functions Z7 and Z8 of Zernike polynomials on the first-order coma aberration include terms of the third or lower orders of the radius r. On the other hand, the aberration mode M1 includes terms of the sixth or higher orders of the radius r within the single mode, and the aberration modes M2 and M3 include terms of the fifth or higher orders of the radius r.
Z11=\sqrt{5}(6 r⁴−6 r²+1) (5)
Z7=2\sqrt{2}(3 r³−2 r)cos θ (6)
Z8=2\sqrt{2}(3 r³−2 r)sin θ (7)

Any high-order basis function may be defined for Zernike polynomials and the aberration mode Mi can be approximated by a combination of the basis functions Zj of multiple Zernike polynomials each including high-order terms (i.e., Mi=Σ kjZj). Even so, a base conversion like this still has some practical effects. Specifically, if the main factors of the aberration produced could be attributed to the variation in the base material thickness of the optical disc 7 and the tilt of the optical disc 7 in advance, then even the high-order aberration modes could be corrected sufficiently by taking advantage of that correlation with the number of aberration modes to be detected reduced significantly. As can be seen from Equations (1), (2) and (3), when the aberration is caused by the variation in the base material thickness of the optical disc 7 or the tilt of the optical disc 7, the high-order terms on the radius r have a relatively low degree of convergence. Accordingly, if basis functions Zi of Zernike polynomials were picked to process aberration modes, quite a few pairs of photodetectors should be provided for the modes of all orders. Or even if only the low-order modes should be corrected, the high-order modes would produce significant residual errors. In contrast, if the aberration modes M1, M2 and M3 associated with the variation in the base material thickness of the optical disc 7 and the tilt of the optical disc 7 are selected, then the aberration of each order can be detected within itself up to the very highest order. In addition, each photodetector can detect a greater quantity of light and ensures a much better SNR.

The photodetector 11 outputs signals S1 through S4 representing the respective magnitudes of these aberration modes M1 through M4. Also, a signal S5, which has been modulated by the pre-pits and recording marks on the optical disc 7, is obtained from the beam spot of the zero-order light beam of the hologram 9. The photodetector 11 will be described more fully later. It should be noted that the respective coefficients of Equations (1), (2) and (3) were obtained under the conditions that the optical disc 7 had a standard base material thickness of 85 μm, an NA of 0.85, and a disc substrate refractive index of 1.62. These numerical values themselves may change according to the combination of these conditions.

The light source 1, collimator lens 2, polarization beam splitter 3, quarter-wave plate 4, deformable mirror 5, objective lens actuator 8, hologram 9, lens 10, and photodetector 11 are fixed on an optical pickup base (not shown), while the objective lens 6 is supported in rotatable position over that optical pickup base by a supporting structure including four wires, for example.

The control section 12 shown in FIG. 1 includes a wavefront calculator 13, a lens shift correction calculator 14, an overall controller 15, and a wavefront correction controller 16.

The wavefront calculator 13 calculates a phase function ψ(x, y) (where x and y are coordinates representing the mirror position of the deformable mirror 5) based on the output signals S1, S2 and S3 of the photodetector 11 in order to correct the wavefront aberration caused by the variation in the base material thickness of the optical disc 7 and by the tilt of the optical disc 7. More specifically, the phase function ψ(x, y) is calculated in the following manner. First, the coefficients A1, A2 and A3 of the basis functions M1, M2 and M3 are obtained based on the signals S1, S2 and S3. Next, the phase function ψ(r, θ), represented by the polar coordinates on the plane of the hologram 9, are derived by Equations (1), (2), (3) and (8):
ψ(r, θ)=Σ AiMi (8)

Next, the wavefront calculator 13 converts the phase function ψ(r, θ) represented by the polar coordinates on the plane of the hologram 9 into a phase function ψ(x, y) represented by the orthogonal coordinates on the plane of the deformable mirror 5. The phase function ψ(x, y) obtained in this manner is output to the lens shift correction calculator 14.

The lens shift correction calculator 14 receives the magnitude of lens shift x0 of the objective lens 6 from the overall controller 15 and converts the phase function ψ(x, y), supplied from the wavefront calculator 13, into ψ(x−x0, y) based on the magnitude of lens shift x0. This function ψ(x−x0, y) is used as a target wavefront when the wavefront correction controller 16 controls the deformable mirror 5.

In accordance with the outputs S4 and S5 of the photodetector 11, the overall controller 15 generates a focus control signal Fo and a tracking control signal Tr for the objective lens actuator 8. Also, by passing this tracking control signal Tr through a low pass filter, the overall controller 15 calculates the magnitude of lens shift x0 of the objective lens 6. However, the magnitude of lens shift x0 may be obtained by any other method. For example, the displacement of the objective lens 6 with respect to the base of the optical pickup may be sensed by a displacement sensor.

In accordance with the output ψ(x−x0, y) of the lens shift correction calculator 14, the wavefront correction controller 16 controls the displacement and tilt of each of the micromirrors 5b in the deformable mirror 5. The operation of the wavefront correction controller 16 will be described more fully later. Anyway, when the control converges, the overall reflective surface shape of the deformable mirror 5 will be a good approximation of the target wavefront shape. This phase function ψ(x−x0, y) is obtained by shifting the phase function ψ(x, y) by the magnitude of lens shift x0 of the objective lens 6 while maintaining its original waveshape. Consequently, the wavefront correction pattern will keep on shifting on the deformable mirror 5 so as to keep up with the shifting position of the objective lens 6.

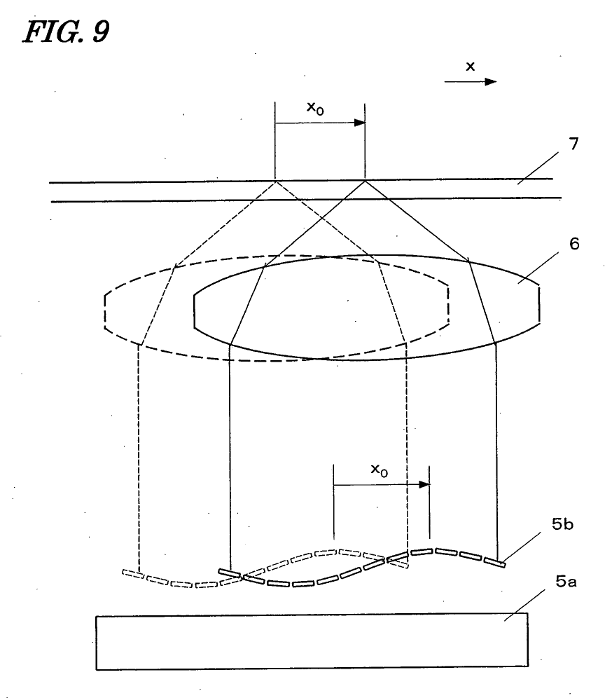

FIG. 9 schematically illustrates how the wavefront correction pattern shifts as the objective lens 6 shifts. In FIG. 9, the dashed lines represent the original non-shifted position, while the solid lines represent the shifted position. Also, as pointed by the arrow in FIG. 9, the x direction is defined rightward. As can be seen from FIG. 9, when the objective lens 6 shifts in the x direction by x0, the displacement and tilt of each micromirror 5b will change, thereby shifting the overall reflective surface in the x direction by x0, too. The beam spot of the light beam striking the deformable mirror 5 may have a diameter on the order of several millimeters, for example. In contrast, the magnitude of lens shift x0 is within the range of about 0 μm to about 200 μm. Accordingly, the magnitude of lens shift x0 is much smaller than the overall size of the wavefront correction pattern.

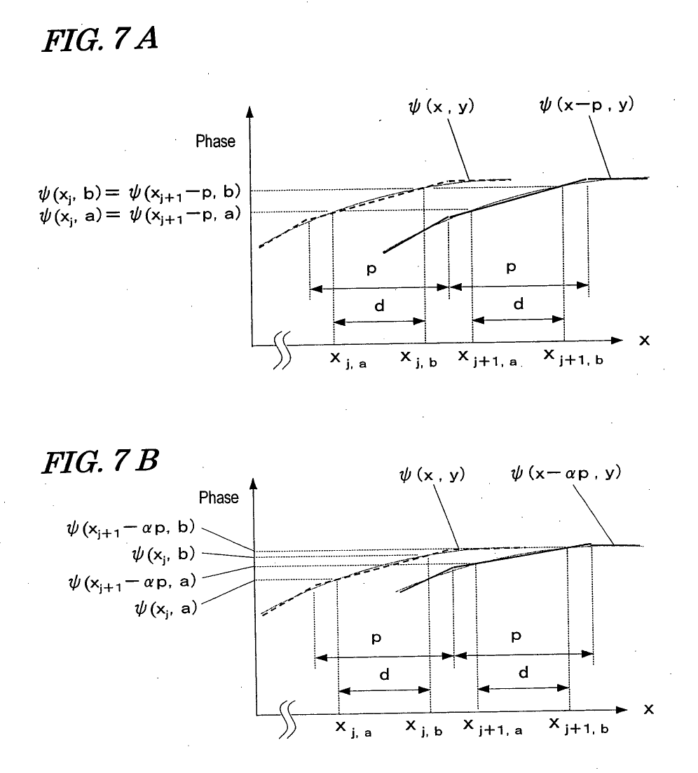

It should be noted that even if the magnitude of lens shift x0 is smaller than the arrangement pitch of the micromirrors 5b, the wavefront correction pattern still needs to be shifted appropriately. As will be described in detail later with reference to FIG. 7, the deformable mirror 5 of this preferred embodiment can cope with even a very small lens shift x0 properly.

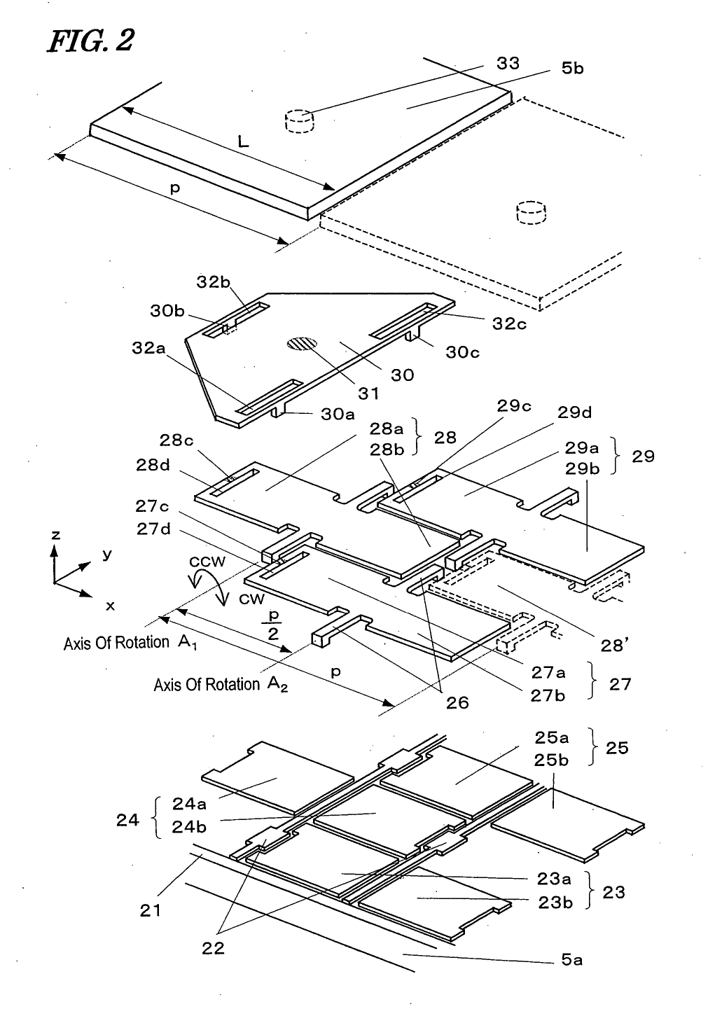

Next, referring to FIG. 2, illustrated is an exploded perspective view of the deformable mirror 5 of this preferred embodiment. In FIG. 2, just one correcting element is illustrated on a large scale. But an actual deformable mirror 5 is a two-dimensional array in which a lot of correcting elements are arranged in columns and rows on the substrate 5a.

As the fixed portion of the driving portion 5c, an insulating layer 21 is provided on a substrate 5a and a base 22 and three pairs of fixed electrodes 23, 24 and 25 are arranged on the insulating layer 21 as shown in FIG. 2. The base 22 and fixed electrodes 23 to 25 are formed by patterning a conductive film of aluminum (Al), polysilicon or any other suitable material. Each of these fixed electrodes 23, 24 and 25 is divided into two fixed-electrode pieces 23a & 23b, 24a & 24b and 25a & 25b. These fixed-electrode pieces 23a, 23b, 24a, 24b, 25a and 25b are connected to the driver circuit on the substrate 5a by way of via metals (not shown), which are provided in the insulating layer 21. The driver circuit can apply mutually independent voltages, all of which fall within the range of 0 V to 5 V, to the fixed-electrode pieces 23a, 23b, 24a, 24b, 25a and 25b. Each of the voltages applied to these six fixed-electrode pieces 23a, 23b, 24a, 24b, 25a and 25b may be set to a multi-bit value of around 16 bits, for example. On the other hand, the base 22 is grounded.

As the movable portion of the driving portion 5c, three yokes 27, 28 and 29 are secured with a pair of hinges 26. Furthermore, an intermediate coupling member 30 for coupling these yokes 27, 28 and 29 to the micromirror 3b is also provided. In this preferred embodiment, the hinges 26 are bonded to the base 22.

These yokes 27, 28 and 29 face their associated fixed electrodes 23, 24 and 25, respectively, so as to function as “movable electrodes”. The yokes 27, 28 and 29 are formed by patterning an electrically conductive material such as aluminum (Al) or polysilicon, and are electrically continuous with the base 22 so as to have the ground potential. Each of these yokes 27, 28 and 29 has a first portion 27a, 28a or 29a and a second portion 27b, 28b or 29b, which respectively face the fixed-electrode pieces 23a & 23b, 24a & 24b and 24a & 25b. These yokes 27, 28 and 29 have quite the same shape. Thus, any statement that applies to one of these three yokes automatically applies to the other two unless stated otherwise.

The yoke 28 is supported so as to rotate around an axis of rotation A1, while the other yokes 27 and 29 are supported so as to rotate around another axis of rotation A2. Supposing a direction perpendicular to the axis of rotation A1 (or A2) is an x direction and the driving portions are arranged at a pitch p in the x direction, the axes of rotation A1 and A2 are defined so as to shift from each other by a half pitch (=p/2) in the x direction. In this manner, the yokes that are adjacent to each other in the y direction are arranged in a checkerboard pattern so as to shift from each other by the half pitch in the x direction. One of the hinges 26 to support the yoke 27 is provided to extend in the gap between the yoke 28 and the yoke 28′ of the adjacent driving portion. In this manner, the hinge 26 can have an extended length in the y direction without interfering with the adjacent yoke 28′. As a result, the spring constant of the hinge 26 can be decreased about the rotation of the yoke. In addition, the decrease in the area of the yoke, which directly affects the rotational force, can be minimized, too. Even if the hinges 26 and yokes 27, 28 and 29 of the same material are formed in the same process so as to have the same thickness as in this preferred embodiment, the rigidity of the yokes 27, 28 and 29 and the flexibility of the hinges 26 can be maintained at the same time.

For example, if a drive voltage is applied to the fixed-electrode piece 23a, then the first portion 27a of the yoke 27 will be attracted toward the fixed-electrode piece 23a. On the other hand, if a drive voltage is applied to the fixed-electrode piece 23b, then the second portion 27b will be attracted toward the fixed-electrode piece 23b. In this manner, the rotational force can be selectively produced around the axis A of rotation either clockwise CW or counterclockwise CCW.

The yoke 27 is coupled to the protrusion 30a of the intermediate coupling member 30 at the drive point 27c (indicated by hatching in FIG. 2) in the vicinity of one free end of the first portion 27a. A groove hole 27d is provided through the yoke 27 near the drive point 27c. This groove hole 27d achieves the following two effects at the same time. One of the two effects is to relax the torsional stresses when the yokes 27, 28 and 29 displace independently and thereby minimize the crosstalk of the displacements among the yokes. The other effect is to strike an adequate balance between the degree of upward displacement of the drive point 27c (i.e., in the positive z direction) and that of downward displacement thereof (i.e., in the negative z direction). Since the groove hole 27d is provided, the area of the first portion 27a is smaller than that of the second portion 27b and the rotational torque generated counterclockwise CCW around the axis of rotation A2 is smaller than that generated clockwise CW around the same axis of rotation A2. Accordingly, when the drive point 27c displaces due to the rotation of the yoke 27 around the axis of rotation A2, the upward displacement thereof should be greater than the downward displacement thereof. Meanwhile, electrostatic attraction between the yoke 27 and the fixed electrode 23 produces not just simple rotational deformation but also downward flexural deformation at the hinges 26. As a result, no matter whether the fixed electrode piece 23a or the fixed electrode piece 23b is driven, downward displacement is produced at the drive point 27a. The displacement of the drive point 27c becomes the sum of the rotational displacement and the flexural displacement. Accordingly, the difference between the upward and downward displacements is canceled and the balance between the displacements in these two directions improves. In addition, both the rotational displacement and flexural displacement are linearly proportional to the electrostatic attraction. For that reason, if the area of the groove hole 27d is defined appropriately based on the magnitudes of the torsional rigidity and flexural rigidity of the hinges 26, an adequate balance can be struck between these magnitudes of displacements over a broad displacement range. In this preferred embodiment, the latter effect is achieved by providing the groove hole 27d. However, the same effect is also achieved in any arbitrary configuration by decreasing the rotational torque in the direction in which the drive point 27c is attracted. For that purpose, the area of the first portion 27a may be set smaller than that of the second portion 27b or the area of the fixed electrode piece 23a may be set smaller than that of the fixed electrode piece 23b, for example. By adopting any of these configurations, the magnitudes of displacements of the drive point 27c can be controlled symmetrically both upward and downward with the voltages being applied to the fixed electrode pieces 23a and 23b regulated.

The intermediate coupling member 30 includes three protrusions 30a, 30b and 30c, which are coupled to the drive point 27c of the yoke 27, the drive point 28c of the yoke 28 and the drive point 29c of the yoke 29, respectively. Accordingly, by driving and rotating the yokes 27, 28 and 29 independently of each other, the displacements of the protrusions 30a, 30b and 30c are controllable independently and the position of the intermediate coupling member 30 is fixed. Groove holes 32a, 32b and 32c are provided through the intermediate coupling member 30 in the vicinity of the protrusions 30a, 30b and 30c, respectively. Just like the groove holes 27d, 28d and 29d of the yokes 27, 28 and 29, these groove holes 32a, 32b and 32c relax the torsional stresses to be produced when the yokes 27, 28 and 29 displace independently, thereby minimizing the crosstalk of the displacements among the yokes.

The micromirror 5b may be made of an SOI wafer, which is preferably different from the material of the substrate 5a, and is Au-bonded to the hatched portion 31 of the intermediate coupling member 30 by way of a protrusion 33. The micromirror 5b and the intermediate coupling member 30 are coupled together. Thus, the position of the micromirror 5b is determined by that of the intermediate coupling member 30. The micromirrors 5b are arranged at a pitch p in the x direction and have a mirror length L as measured in the x direction.

As is clear from the foregoing description of the configuration of this preferred embodiment, by applying drive voltages selectively and independently to the fixed-electrode pieces 23a, 23b, 24a, 24b, 25a and 25b, the micromirror 5b can be driven bidirectionally (i.e., in positive and negative directions), no matter whether the micromirror 5b needs to be displaced in the z direction or tilted around the x axis and/or y axis.

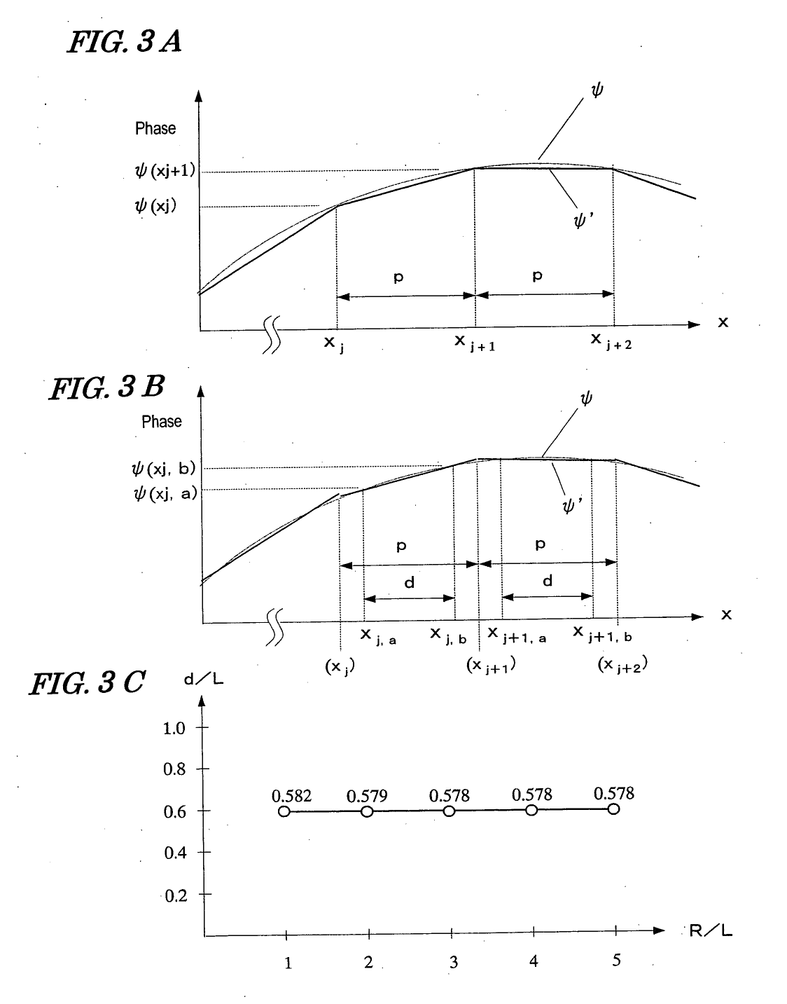

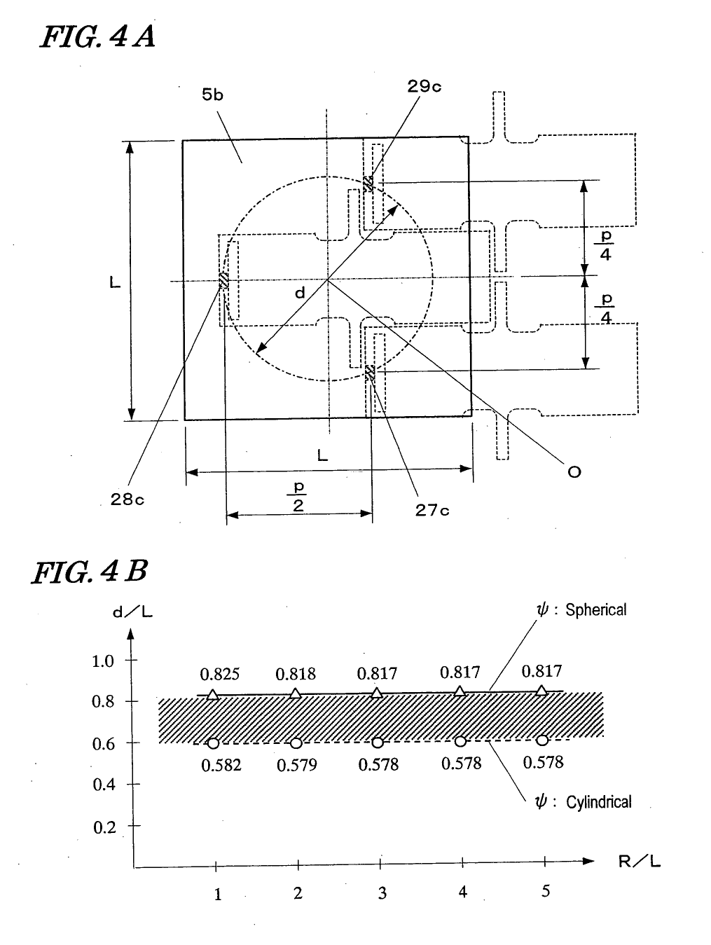

Hereinafter, it will be described with reference to FIGS. 3A through 4C how to define the coordinates of the drive points 27c, 28c and 29c to improve the polygonal line approximation accuracy of the wavefront of the deformable mirror 5. FIGS. 3A, 3B and 3C are graphs showing the relationships between the drive points of the deformable mirror 5 and the wavefront approximation accuracy. These relations will be described with one-dimensional graphs first for the sake of simplicity.

First, a normal wavefront polygonal line approximation method will be described with reference to FIG. 3A.

In FIG. 3A, the abscissa represents the x coordinate of a drive point on the deformable mirror 5 and the ordinate represents the wavefront phase. A phase function ψ, which is the target of correction for the deformable mirror 5, is indicated by the two-dot chain. As described above, the phase function ψ is given as a function of the x coordinate. Each micromirror 5b in the deformable mirror 5 can have its displacement and tilt with respect to the substrate 5a controlled. Accordingly, this phase function ψ is reproduced by the polygonal line approximation. The micromirrors 5b are arranged at a pitch p in the x direction. Thus, coordinates xⱼ (where j is an integer) may be defined at the regular interval of p, and the displacement and tilt of the micromirror 5b may be obtained so as to connect together the two points ψ(xj) and ψ(xj+1) of the phase function ψ that are associated with two adjacent coordinates xⱼ and xⱼ₊₁. This approximated polygonal line ψ′ is indicated by the solid line in FIGS. 3A and 3B. This method requires a low degree of computational complexity and ensures high-speed computation but results in a significant wavefront error.

In another polygonal line approximation method, the displacement and tilt of the micromirror that minimizes the error with respect to the phase function ψ may be obtained by a least square approximation method for every interval [xⱼ, xⱼ₊₁]. According to this method, the wavefront error can be reduced but the computational complexity increases too much.

Thus, there is an alternative wavefront polygonal line approximation method, which ensures higher accuracy with the computational complexity cut down, as shown in FIG. 3B. In this method, two more coordinates x_{j, a} and x_{j, b} are defined within the interval [xⱼ, xⱼ₊₁]. These coordinates x_{j, a} and x_{j, b} are symmetrical with respect to the center of the mirror and are spaced apart from each other by a distance d. Suppose the mirror surface should be defined as a line segment that passes the coordinates (x_{j, a}, ψ(x_{j, a})) and (x_{j, b}, ψ(x_{j, b})) by setting this distance d to an appropriate value.

FIG. 3C shows the relationship between the radius of curvature R of the phase function ψ and the distance d that results in a local minimum wavefront error in the interval [xⱼ, xⱼ₊₁]. More specifically, the abscissa represents the dimensionless radius of curvature R/L, where L is the mirror length, while the ordinate represents the dimensionless distance d/L that results in a local minimum wavefront error. The wavefront error is defined as the root of ∫(ψ−ψ′)² dx, which is the definite integral of the squared error in the mirror with the length L. The radius of curvature R of the phase function ψ may have any arbitrary value. However, as can be seen from FIG. 3C, the dimensionless distance d/L that results in a local minimum wavefront error hardly depends on the dimensionless radius of curvature R/L and always has a substantially constant value of about 0.58. Accordingly, if the coordinates x_{j, a} and x_{j, b} with the distance d set equal to 0.58 L are defined as the coordinates of the drive points of the deformable mirror 5 and if the target displacement values of these drive points are set to ψ(x_{j, a}) and ψ(x_{j, b}), respectively, then the wavefront error can be just about as small as that obtained by the least square approximation method. In addition, the target displacement value of the drive point can be directly calculated from the phase function ψ, and therefore, the computational complexity can be reduced significantly.

Next, a two-dimensional model, obtained by expanding these fundamentals, will be described with reference to FIGS. 4A and 4B, which show two-dimensional relationships between the drive points of the deformable mirror 5 and the wavefront approximation accuracy.

Specifically, FIG. 4A is a plan view of the deformable mirror 5 including the micromirror 5b and drive points 27c, 28c and 29c. As shown in FIG. 4A, these drive points 27c, 28c and 29c are substantially located on a circle that is drawn around the center O of the micromirror 5b so as to have a diameter d.

FIG. 4B shows the relationship between the radius of curvature R of the phase function ψ and the distance d that results in a local minimum wavefront error within the micromirror 5b. The micromirror 5b is supposed to be a square with a length L each side. In FIG. 4B, the abscissa represents the dimensionless radius of curvature R/L, while the ordinate represents the dimensionless distance d/L that results in a local minimum wavefront error. The wavefront error is defined as the root of ∫∫(ψ−ψ′)² dxdy, which is the definite integral of the squared error within the L×L mirror plane.

The results obtained when the phase function ψ was supposed to be spherical are indicated by the solid line in FIG. 4B. As can be seen from FIG. 4B, the dimensionless distance d/L that results in a local minimum wavefront error hardly depends on the dimensionless radius of curvature R/L and always has a substantially constant value of about 0.82. The results obtained by the one-dimensional model described above are also indicated by the dashed line in FIG. 4B. This corresponds to a situation where the phase function ψ is a cylindrical body having curvature only in the x direction and no curvature in the y direction. As described above, the dimensionless diameter d/L is about 0.58. Supposing the flattening is zero when the phase function ψ is spherical and one when the phase function ψ is cylindrical, respectively, a normal wavefront has an intermediate flattening. Accordingly, as indicated by hatching in FIG. 4B, the dimensionless diameter d/L may fall within the range of 0.58 to 0.82.

In this manner, by setting the drive points 27c, 28c and 29c in the area between a first circle with a diameter d of 0.58 L and a second circle with a diameter d of 0.82 L so that these circles are both drawn around the center O of the micromirror 5b, the wavefront error approximation accuracy can be increased. Since the target displacement of each of the drive points 27c, 28c and 29c is directly calculated by inputting the coordinates (x, y) thereof into the phase function ψ, the computational complexity is extremely low. Furthermore, in this preferred embodiment, the coordinates of the drive points are defined in a simple lattice shape with translational vectors (p/2, p/4) and (p/2, −p/4) as shown in FIG. 4A. Accordingly, in each and every micromirror 5b, the coordinates can be set just by performing simple increment operations.

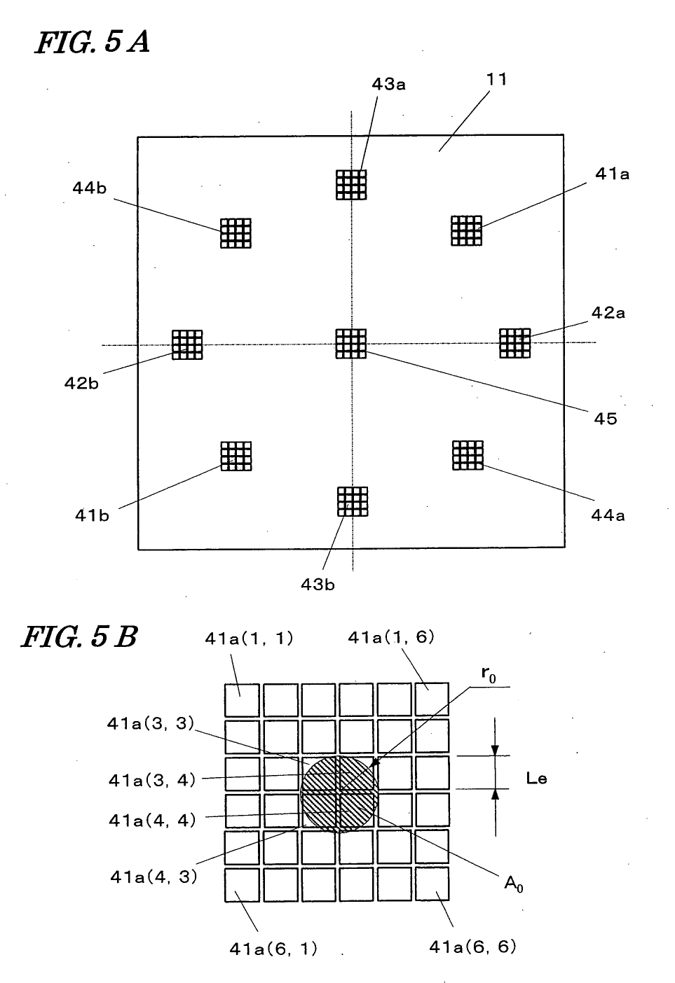

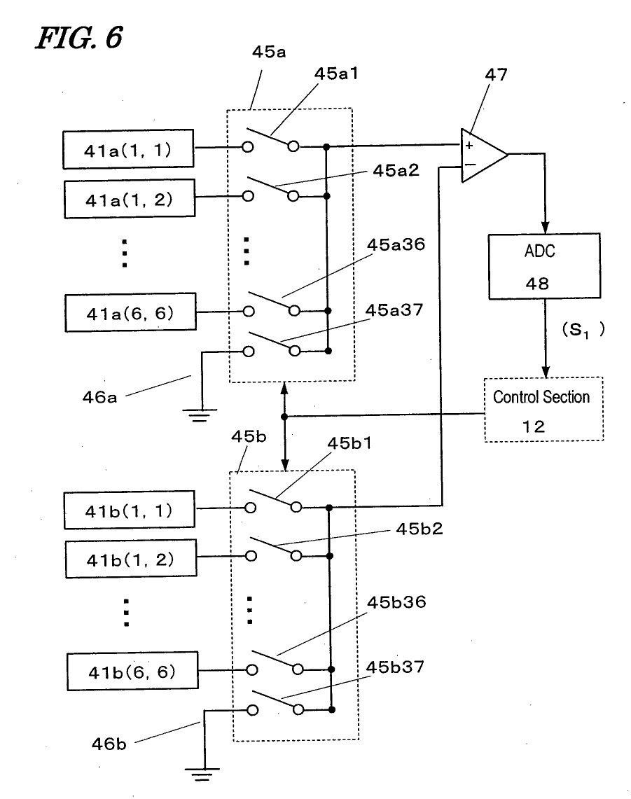

Next, the photodetector 11 will be described in detail with reference to FIGS. 5A, 5B and 6. FIGS. 5A and 5B are plan views illustrating the photosensitive portion of the photodetector 11 of this preferred embodiment, which is preferably implemented as an array of PIN diodes in this preferred embodiment.

As shown in FIG. 5A, the photodetector 11 has four pairs of photosensitive areas 41a & 41b, 42a & 42b, 43a & 43b and 44a & 44b, which are associated with the aberration sensing differential signals S1, S2, S3 and S4, respectively, and one more photosensitive area 45 associated with the disc information detecting signal S5.

The photosensitive areas 41a and 41b receive +first-order light beam and −first-order light beam, respectively, in order to detect the spherical aberration mode M1 associated with the variation in the base material thickness of the disc. The photosensitive areas 42a and 42b receive +first-order light beam and −first-order light beam, respectively, in order to detect the spherical aberration mode M2 associated with the radial tilt of the disc. The photosensitive areas 43a and 43b receive +first-order light beam and −first-order light beam, respectively, in order to detect the spherical aberration mode M3 associated with the tangential tilt of the disc. And the photosensitive areas 44a and 44b receive +first-order light beam and −first-order light beam, respectively, in order to detect the spherical aberration mode M4 associated with the defocusing of the objective lens 6.

FIG. 5B is an enlarged view of the photosensitive area 41a. Although not shown, each of the other photosensitive areas basically has the same structure as this photosensitive area 41a. As shown in FIG. 5B, the photosensitive area 41a is made up of 6×6 electrically isolated photodiodes 41a (1, 1) through 41a (6, 6). Each of these photodiodes 41a (1, 1) through 41a (6, 6) is connected to its associated interconnect by way of either a transparent electrode of ITO, for example, or a via metal, which is electrically in contact with a lower interconnect layer. In any case, those interconnects are provided so as not to extend along the gaps between the photodiodes. As a result, each photodiode can have an increased effective photosensitive area.

In FIG. 5B, the hatched circle represents the size of the beam spot A0 with no aberrations. The airy disk radius of this beam spot A0 will be identified by r0. The size Le of each photodiode is smaller than this airy disk radius r0. In detecting the quantity of light received at the photosensitive area 41a, just a few photodiodes that are located around the center of the beam spot A0 are selectively used from among the photodiodes 41a (1, 1) through 41a (6, 6). In the situation illustrated in FIG. 5B, the output signals of only the four central photodiodes 41a (3, 3), 41a (3, 4), 41a (4, 3) and 41a (4, 4) are detected effectively. If the center of the beam spot A0 has shifted due to a temperature variation, for example, then another set of four photodiodes, surrounding that shifted beam spot center, is newly used. In this manner, photodiodes to activate are selected from a plurality of very small photodiodes and are operated so as to detect the light intensity only around the center of the beam spot A0. This detection scheme will be described more fully with reference to FIG. 6.

FIG. 6 shows a schematic configuration for the detector circuit of the photodetector 11 of this preferred embodiment. The circuit configuration shown in FIG. 6 is provided for the photosensitive areas 41a and 41b but substantially the same circuit configuration may be used for any other pair of photosensitive areas. As shown in FIG. 6, one selector 45a includes thirty-six switches 45a1 through 45a36, which are connected to the respective terminals of the photodiodes 41a (1, 1) through 41a (6, 6) of the photosensitive area 41a, and another switch 45a37, which is connected to a ground terminal 46a. The selector 45a selectively connects an arbitrary one of these thirty-seven terminals to the non-inverting input terminal of a differential amplifier 47. The other selector 45b also includes thirty-six switches 45b1 through 45b36, which are connected to the respective terminals of the photodiodes 41b (1, 1) through 41b (6, 6) of the photosensitive area 41b, and another switch 45b37, which is connected to a ground terminal 46b. The selector 45b selectively connects an arbitrary one of these thirty-seven terminals to the inverting input terminal of the differential amplifier 47.

The analog amplified output of the differential amplifier 47 is converted by an A/D converter 48 into digital data, which is then supplied to the control section 12.

For example, when the drive is started up or when the temperature sensor (not shown) senses a temperature variation, which is equal to or greater than a predetermined value, in the drive, the control section 12 performs the photodiode selecting operation in order to correct the shift of the beam spot. In that case, the light source 1 is turned ON and the photodetector 11 is ready to receive the light reflected from the optical disc 7.

To pick the four photodiodes from the photosensitive area 41a, first, the selector 45b turns only the switch 45b37 ON, thereby connecting the inverting input terminal of the differential amplifier 47 to the ground terminal 46b. Meanwhile, the selector 45a sequentially turns ON one of the thirty-six switches 45a1 through 45a36 after another. Then, the output of each of the photodiodes 41a (1, 1) through 41a (6, 6) is amplified by the differential amplifier 47 and then converted into digital data by the A/D converter 48. Thereafter, the output data of these photodiodes are stored in the memory in the control section 12. These output data represent a light quantity distribution in the photosensitive area 41a. The control section 12 compares those output data with each other, regards the photodiode with the highest light quantity as having the center of the beam spot, and picks the four photodiodes surrounding the center of that beam spot.

The four photodiodes are picked from the photosensitive area 41b in quite the same way. Specifically, first, the selector 45a turns only the switch 45a37 ON, thereby connecting the non-inverting input terminal of the differential amplifier 47 to the ground terminal 46a. Meanwhile, the selector 45b sequentially turns ON one of the thirty-six switches 45b1 through 45b36 after another. Then, the output of each of the photodiodes 41b (1, 1) through 41b (6, 6) is amplified by the differential amplifier 47 and then converted into digital data by the A/D converter 48. Thereafter, the output data of these photodiodes are stored in the memory in the control section 12. These output data represent a light quantity distribution in the photosensitive area 41b. The control section 12 compares those output data with each other, regards the photodiode with the highest light quantity as having the center of the beam spot, and picks the four photodiodes surrounding the center of that beam spot.

When the photodiodes are picked in this manner, the control section 12 instructs the selectors 45a and 45b to switch connections so as to generate the aberration detection signal S1. In response, the selector 45a turns ON the switches that are connected to the terminals of the four activated photodiodes and connects those photodiodes to the non-inverting input terminal of the differential amplifier 47. In the same way, the selector 45b turns ON the switches that are connected to the terminals of the four activated photodiodes and connects those photodiodes to the inverting input terminal of the differential amplifier 47.

Then, the differential amplifier 47 outputs a differential amplified signal, representing the difference between the quantities of light received by a pair of associated photodiodes that has been selected from the photosensitive areas 41a and 41b, respectively. By getting this differential amplified signal converted into digital data by the A/D converter 48, the aberration detection signal S1 can be obtained.

Unless the control section 12 instructs the selectors 45a and 45b to re-correct the beam spot location, the selectors 45a and 45b maintain this connection, thereby always outputting the effective aberration detection signal S1 while the optical disc drive is performing a read or write operation. As a result, the aberration can be detected with good responsivity.

In addition, since the optical disc drive is always ready to cope with beam spot shifting, the photodetector 11 requires much lower assembling accuracy. Accordingly, the optical disc drive can exhibit increased reliability because its performance is not so easily affected by beam spot shifting due to some state transition (e.g., a variation in temperature).

Furthermore, since the selectors 45a and 45b are provided between the photodiodes and the differential amplifier 47, the number of differential amplifiers 47 or A/D converters 48 required can be much smaller than that of the photodiodes. As a result, the circuit configuration can be simplified drastically and the circuit cost and power dissipation thereof can be cut down significantly.

Each of the other signals S2, S3 and S4 is generated by the same configuration as that just described. The signal S5 is also generated by a similar configuration although the signal S5 is not a differential signal. In this manner, the signal S5 is also produced by a confocal optical system that uses only very small effective photosensitive areas such as these. Consequently, the unwanted effects of stray light coming from another layer in the multilayer disc can be reduced.

In the preferred embodiment described above, the number of photodiodes to activate is supposed to be four and those photodiodes are supposed to be arranged in a square pattern. However, the number or arrangement pattern of the photodiodes may be changed either on an aberration mode basis or time sequentially. More particularly, the number of photodiodes to activate may be relatively large at first so as to control the aberration coarsely even if the beam spot location has shifted to a certain degree. And after the aberration has been controlled coarsely and after the beam spot location has been detected successfully, the number of photodiodes to activate may be decreased so as to make a finer adjustment. This technique is particularly effective in converging both the aberration and beam spot location toward target accuracies quickly and increasing the reliability of operation in a situation where a transitional significant aberration decreases the beam spot location detection accuracy.

As to the possible shift of the beam spot center to be caused due to an assembling error of the drive, the beam spot center in the assembled drive is already located in advance and the location data is stored in a ROM in the control section 12. Thus, that location data is read out and used when the drive is started up.

Hereinafter, the operation of the optical disc drive of this preferred embodiment will be further described with reference to FIG. 1 again.

When the drive is started, the light source 1 is turned ON, the deformable mirror 5 is flattened, and the light beam is focused by the objective lens 6 onto a target data storage layer of the optical disc 7. In this case, the target data storage layer is supposed to be located between the uppermost and lowermost layers, and the spherical aberration of the objective lens 6 is supposed to be minimized when the light beam is focused on that data storage layer while the deformable mirror 5 is kept flat. Also, the photodetector 11 detects the beam spot location and determines the photodiodes to activate.

Thereafter, the objective lens 6 is moved to a target track on the data storage layer from/on which data should be actually read or written. In this case, in response to the tracking control signal Tr, the overall controller 15 outputs the magnitude of lens shift x0 of the objective lens 6. Meanwhile, the photodetector 11 outputs the aberration signals S1, S2 and S3 to the wavefront calculator 13, which calculates a phase function ψ(x, y), which has been converted so as to represent the reflective surface of the deformable mirror 5, based on these signals.

Subsequently, the phase function ψ(x, y) is further shifted by the magnitude of lens shift x0 by the lens shift correction calculator 14 and converted into ψ(x−x0, y), which is used as the target wavefront in controlling the deformable mirror 5. Next, the wavefront correction controller 16 substitutes the coordinates of the drive points of each micromirror 5b into the phase function ψ(x−x0, y) representing the target wavefront, thereby defining the target displacement and performing a closed loop control with a predetermined gain constant multiplied. As a result, the wavefront aberration modes M1, M2 and M3 associated with the variation in the base material thickness of the optical disc 7 and the tilt of the optical disc 7 are corrected.

As described above, as to the aberration modes M1, M2 and M3 associated with the variation in the base material thickness of the optical disc 7 and the tilt thereof and the aberration mode M4 associated with defocusing, the wavefront is sensed with the photodetector 11 that is designed such that the aberration modes to be detected are perpendicular to each other. On the other hand, as to the aberration that is caused by the lens shift and not perpendicular to any of these aberration modes M1 through M4, that aberration is not measured directly but the magnitude of lens shift x0 of the objective lens 6 is detected and the coordinates of the phase function ψ(x, y) are shifted by x0, thereby applying the converted phase function to the deformable mirror 5. Thus, the mode-to-mode interference can be minimized and the approximation accuracy can be increased by a simple configuration while the aberrations are being detected.

Just like the basis function Zi of the Zernike polynomial, the aberration modes M1 through M4 are invariant with respect to the rotation of any coordinate axis. That is to say, M1 and M4 satisfy rotation symmetry and M2 and M3 can represent any rotated mode as a combination of M2 and M3. To correct the lens shift using such a system that is invariant with respect to the rotation of a coordinate axis, a number of aberration modes are usually needed from a low order up to a high order. However, by using the configuration described above, the aberrations can be corrected highly precisely just by combining a small number of aberration modes.

Hereinafter, it will be described with reference to FIGS. 7A and 7B how to make an appropriate wavefront correction when the lens shift x0 has an arbitrary small value. FIGS. 7A and 7B show corrected wavefront shapes of the deformable mirror 5 in a situation where the objective lens 6 has shifted by x0. These graphs are also shown as one-dimensional graphs for the sake of simplicity.

FIG. 7A shows a situation where the magnitude of lens shift x0 is exactly equal to the pitch p of the micromirrors 5b.

In FIG. 7A, the one-dot chain on the left-hand side represents the phase function ψ(x, y) when there is no lens shift and the dashed polygonal line represents the corrected wavefront shape of the deformable mirror 5. The target displacements of the drive points x_{j, a} and x_{j, b} are ψ(x_{j, a}) and ψ(x_{j, b}), respectively. On the other hand, the two-dot chain on the right-hand side represents the phase function ψ(x−p, y) when there is a lens shift of p and the solid polygonal line represents the corrected wavefront shape of the deformable mirror 5. The target displacements of the drive points x_{j+1, a} and x_{j+1, b} are ψ(xⱼ₊₁−p, a) and ψ(xⱼ₊₁−p, b), respectively.

As is clear from FIG. 7A, if the magnitude of lens shift x0 is exactly-equal to the pitch p of the micromirrors 5b, then the target displacements ψ(xⱼ, a) and ψ(xⱼ, b) of the drive points x_{j, a} and x_{j, b} with no lens shift may be applied as they are to the drive points x_{j+1, a} and x_{j+1, b} of the adjacent micromirror. It is also clear that the corrected wavefront accuracy of the deformable mirror 5 never deteriorates as a result of the lens shift correction.

FIG. 7B shows a situation where the magnitude of lens shift x0 is α·p (where α<1), which is smaller than the pitch p of the micromirrors 5b.

In FIG. 7B, the one-dot chain on the left-hand side represents the phase function ψ(x, y) when there is no lens shift and the dashed polygonal line represents the corrected wavefront shape of the deformable mirror 5. The target displacements of the drive points x_{j, a} and x_{j, b} are ψ(xⱼ, a) and ψ(xⱼ, b), respectively. On the other hand, the two-dot chain on the right-hand side represents the phase function ψ(x−α·p, y) when there is a lens shift of α·p and the solid polygonal line represents the corrected wavefront shape of the deformable mirror 5. The target displacements of the drive points x_{j+1, a} and x_{j+1, b} are ψ(xⱼ₊₁−α·p, a) and ψ(xⱼ₊₁−α·p, b), respectively.

In this case, the target displacements ψ(xⱼ₊₁−α·p, a) and ψ(xⱼ₊₁−α·p, b) of the drive points x_{j+1, a} and x_{j+1, b} when the lens shift is corrected are different from the target displacements ψ(xⱼ, a) and ψ(xⱼ, b) of the drive points x_{j, a} and x_{j, b} when there is no lens shift, thereby increasing the wavefront approximation accuracy.

As can be seen, even if the magnitude of lens shift x0 is smaller than the pitch p of the micromirrors 5b, the target displacement of each micromirror 5b is controlled in multiple steps, thereby changing that target displacement. As a result, the lens shift can be corrected without decreasing the wavefront approximation accuracy. Accordingly, any arbitrary small lens shift x0 can be corrected.

As described above, in the optical disc drive of this preferred embodiment, the wavefront calculator 13 generates a phase function ψ(x, y), representing a correlation between the coordinates of a light beam spot and the wavefront phase, based on the output signals of the photodetector 11. The lens shift correction calculator 14 generates a phase function ψ(x−x0, y), representing a modified correlation between the coordinates of the light beam spot and the wavefront phase, based on the magnitude of lens shift x0. And the wavefront correction controller 16 controls the deformable mirror 5 in accordance with this phase function ψ(x−x0, y). In this configuration, the lens shift can be corrected just by performing computation processing without providing any special member for lens shift correction. In addition, only the micromirror 5b is actually displaced while the lens shift is being corrected. The micromirror 5b has a very small mass and displaces on the order of just several nanometers. Thus, very high-speed response is realized. Furthermore, even if the lens shift is corrected, the wavefront correction accuracy never deteriorates, and the same processing is applicable as it is to any arbitrary wavefront. Moreover, even a very small lens shift can be corrected as well.

In the preferred embodiment described above, M1, M2 and M3 represented by Equations (1), (2) and (3) are used in common as the aberration modes while the photodetector 11 is detecting the aberrations and as the aberration modes while the wavefront calculator 13 is reproducing the phase function ψ(r, θ). However, the present invention is in no way limited to that specific preferred embodiment. Alternatively, the photodetector 11 may detect the aberrations by using the aberration modes Zi of the Zernike polynomials represented by Equations (5), (6) and (7) and the wavefront calculator 13 may reproduce the phase function ψ(r, θ) by using the aberration modes M1 represented by Equations (1), (2) and (3). Similar effects are also achievable even by such an alternative configuration as long as the correlation between the aberration modes Zi and Mi is defined beforehand.

### Embodiment 2

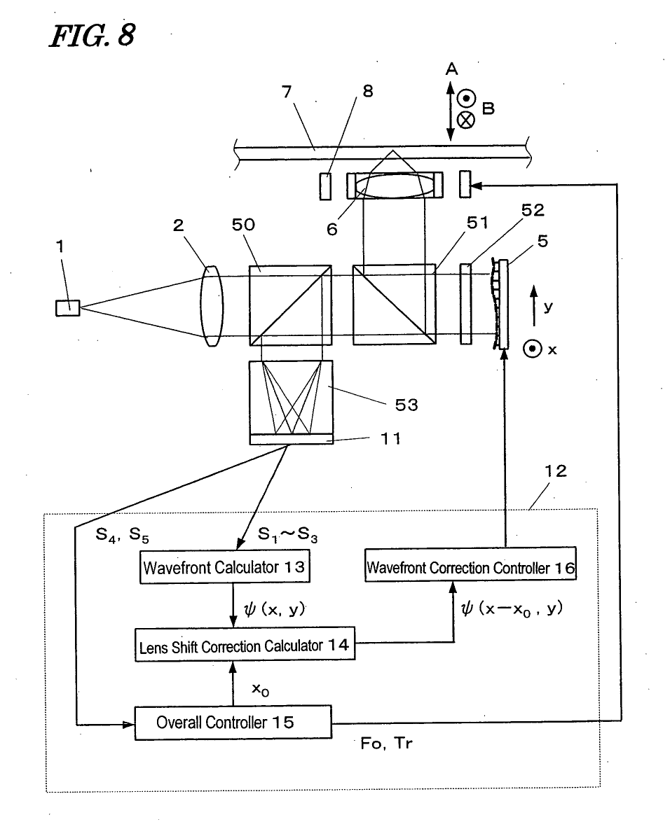

Hereinafter, an optical disc drive according to a second specific preferred embodiment of the present invention will be described with reference to FIG. 8, which schematically illustrates a configuration for the optical disc drive of this second preferred embodiment.

In this second preferred embodiment, the light source 1, collimator lens 2, deformable mirror 5, objective lens 6, optical disc 7, objective lens actuator 8, photodetector 11, control section 12, wavefront calculator 13, lens shift correction calculator 14, overall controller 15 and wavefront correction controller 16 are identical with the counterparts that have already been described for the first preferred embodiment.

A light beam emitted from the light source 1 is transformed by the collimator lens 2 into an parallel light beam, which is then incident onto a half mirror 50. A portion of the light beam that has been transmitted through the half mirror 50 is incident onto a polarization beam splitter 51. Only the P-polarized component of this light beam is transmitted through the polarization beam splitter 51 and then transformed by a quarter-wave plate 52 into circularly polarized light. Thereafter, that circularly polarized light beam is reflected from the deformable mirror 5 so as to have its phase converted and then transmitted through the quarter-wave plate 52 again so as to be converted into an S-polarized component.

This light beam consisting essentially of the S-polarized component is reflected from the polarization beam splitter 51 so as to enter the objective lens 6 and then focused on a data storage layer of the optical disc 7. After having been reflected from the data storage layer of the optical disc 7, the light beam passes the objective lens 6, polarization beam splitter 51 and quarter-wave plate 52 again and impinges on the deformable mirror 5. When reflected from the deformable mirror 5, the light beam has its phase converted again. Thereafter, the light beam passes the quarter-wave plate 52 one more time so as to be converted into a P-polarized component, which is then incident on the half mirror 50.

A portion of that light beam, which has been reflected from the half mirror 50, has its wavefront sensed by a wavefront sensor, which is made up of a hologram 53 and the photodetector 11. The hologram 53 and photodetector 11 are bonded together.

The hologram 53 forms two beam spots, which are quite similar to those formed by the assembly of the hologram 9 and lens 10 as described for the first preferred embodiment. That is to say, as to the aberration modes Mi given by Equations (1) through (4) and their bias coefficient Bi, the hologram 53 forms a beam spot that has been given a bias aberration of +BiMi and a beam spot that has been given a bias aberration of −BiMi. The hologram 53 further forms another beam spot to detect the signal S5 that has been modulated by the pre-pits and recording marks on the optical disc 7, too.

In this preferred embodiment, the light beam is incident perpendicularly onto the deformable mirror 5. Thus, it is much easier for the wavefront calculator 13 to calculate the coordinates representing the mirror position. In addition, the hologram 53 and photodetector 11 are integrated together. Accordingly, the overall configuration and assembly process can be both simplified and an unintentional shift of the beam spot due to a variation in temperature, for example, can be eliminated effectively.

### Embodiment 3

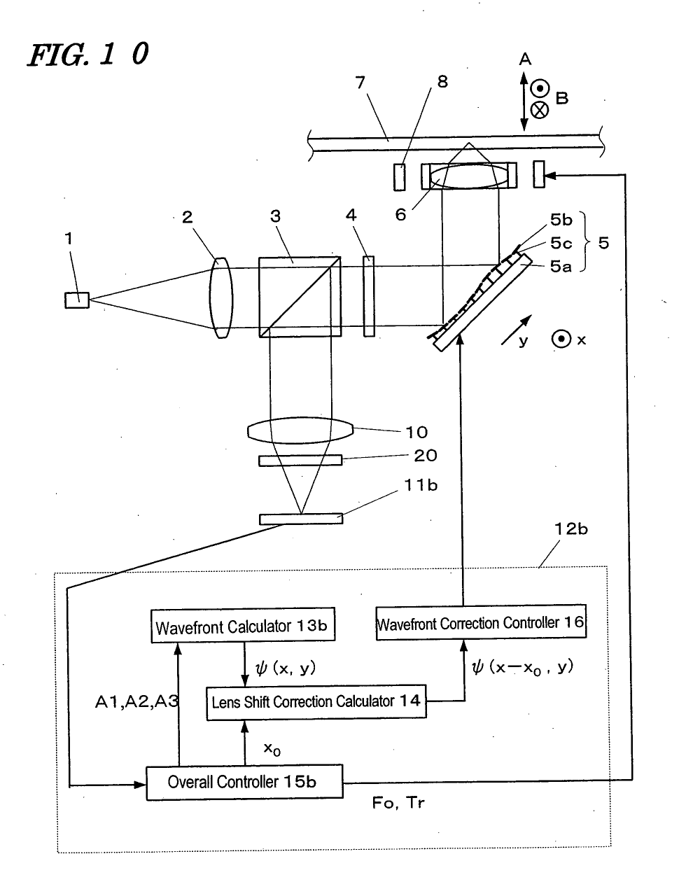

Hereinafter, an optical disc drive according to a third specific preferred embodiment of the present invention will be described with reference to FIG. 10, which schematically illustrates a configuration for the optical disc drive of this third preferred embodiment.

In this third preferred embodiment, the structures and operations of the light source 1, collimator lens 2, polarization beam splitter 3, quarter-wave plate 4, deformable mirror 5, objective lens 6, optical disc 7, objective lens actuator 8, lens 10, lens shift correction calculator 14, and wavefront correction controller 16 are identical with those of the counterparts that have already been described for the first preferred embodiment.

The light beam that has returned from the optical disc 7 to the polarization beam splitter 3 is reflected from the polarization beam splitter 3, passed through the lens 10, given astigmatism by a cylindrical lens 20 and then incident onto a photodetector 11b. The photodetector 11b includes four photosensitive areas (not shown) and generates a focus error signal by an astigmatism method and a tracking error signal by a push-pull method, respectively. Then, the focus error signal and tracking error signal are input to an overall controller 15b.

The overall controller 15b calculates the variation in the base material thickness of the data storage layer of the optical disc 7 and the tilt of the data storage layer and determines the coefficients A1, A2 and A3 of the basis functions M1, M2 and M3 based on the variation and tilt.

The wavefront calculator 13b receives signals representing the coefficients A1, A2 and A3 of the basis functions M1, M2 and M3 from the overall controller 15b and calculates a phase function ψ(x, y) based on the coefficients A1, A2 and A3. Thereafter, a signal representing the phase function ψ(x, y) is supplied to the lens shift correction calculator 14.

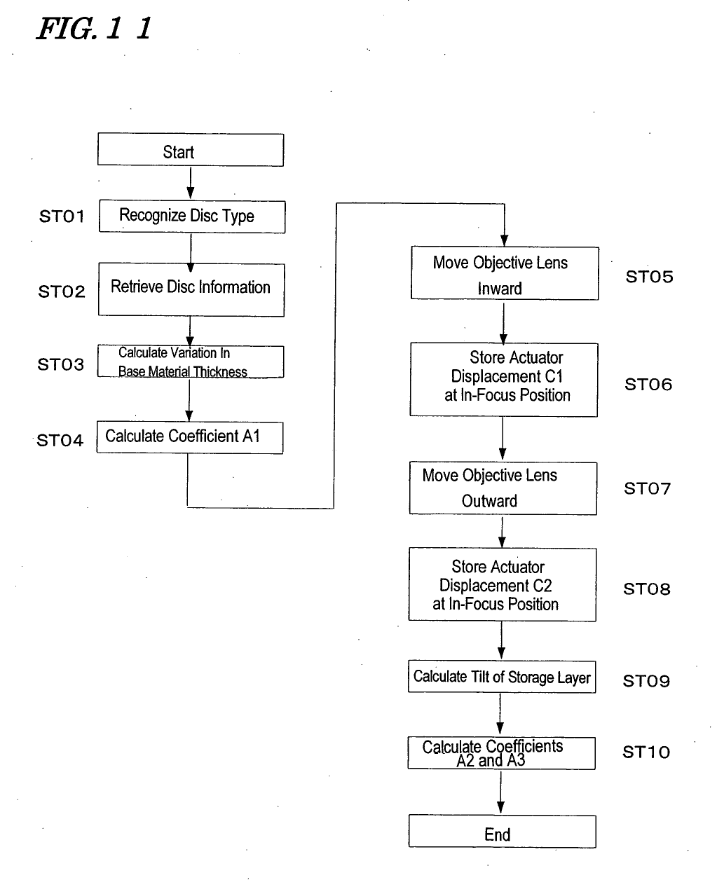

FIG. 11 is a flowchart showing a procedure in which the overall controller 15b determines the coefficients A1, A2 and A3.

First, in Step ST01 shown in FIG. 11, the type of the given optical disc 7 is recognized. This processing step ST01 is carried out as soon as the optical disc 7 is loaded into the drive. Next, in Step ST02, an associated piece of disc information is selectively read out from a variety of disc information stored in a memory (not shown) based on the recognition result obtained in Step ST01. In this case, the disc information includes information about the number of data storage layers included in the optical disc 7 and the base material thickness (i.e., the depth) of each of those data storage layers.

Subsequently, in Step ST03, the variation in the base material thickness of the layer from/on which data should be read or written (which will be referred to herein as a “target data storage layer”) is calculated. The objective lens 6 is designed so as to have a minimum spherical aberration at a predetermined base material thickness. The magnitude of the spherical aberration is proportional to the variation in base material thickness, i.e., the difference between that predetermined base material thickness and the base material thickness of the target data storage layer.

Next, in Step ST04, the coefficient A1 of the basis function M1 is calculated by multiplying the base material thickness variation by a predetermined constant of proportionality.

Then, in Step ST05, the objective lens 6 is moved inward (i.e., toward the inner edge of the optical disc 7). Thereafter, in Step ST06, the objective lens actuator 8 is driven at that inside position, thereby focusing the light beam on the target data storage layer. In this processing step, the magnitude of displacement C1 of the objective lens actuator 8 that has been driven in the focus direction is stored in a memory (not shown).

Subsequently, in Step ST07, the objective lens 6 is moved outward (i.e., toward the outer edge of the optical disc 7) by a predetermined distance D. Thereafter, in Step ST08, the light beam is focused on the target data storage layer, and the magnitude of displacement C2 of the objective lens actuator 8 that has been driven in the focus direction is stored in the memory, as in Step ST06.

Next, in Step ST09, the tilt of the data storage layer is calculated based on the magnitudes of displacements C1 and C2 of the actuator 8 and the distance D. More specifically, the tilt of the data storage layer can be obtained by dividing the difference between the magnitudes of displacements C1 and C2 of the actuator 8 by the distance D.

Finally, in Step ST10, the coefficients A2 and A3 of the basis functions M2 and M3 are calculated by multiplying the tilt of the data storage layer by a predetermined constant of proportionality.

In the preferred embodiment described above, the wavefront function is generated without using any wavefront sensor, and therefore, the photodetector can be implemented as a simplified one. It should be noted that not every data storage layer in the optical disc 7 has to have its base material thickness (or the depth) measured by the method described above. Alternatively, the base material thickness of one data storage layer may also be calculated based on the magnitude of displacement of the objective lens actuator 8 when the actuator 8 focuses the light beam on that data storage layer, for example. The tilt of the data storage layer does not have to be calculated by the above method, either. For example, a tilt sensor for sensing the tilt of the optical disc 7 may be provided separately and the tilt of the data storage layer may be calculated based on the output of the tilt sensor.

Thus, although no wavefront sensor is used according to the preferred embodiment described above, each of the correcting elements (i.e., micromirrors) in the deformable mirror, functioning as wavefront correcting means, may have its position fixed, and then the magnitude of shift of the optical axis of the objective lens from that of the light beam may be detected. Then, the position of each micromirror can be corrected appropriately so as to compensate for that phase shift.

One of the key features of the present invention is that the position of an element functioning as wavefront correcting means is modified according to the magnitude of lens shift. The initial state (or rest position) of that element functioning as wavefront correcting means may be determined not only by sensing the wavefront of the light beam but also by sensing the tilt of the optical disc and the depth of the data storage layer as measured from the surface of the optical disc (i.e., the base material thickness) as well. The tilt of the optical disc is a piece of indispensable information in compensating for a coma aberration, while the base material thickness of the optical disc is a piece of required information in order to compensate for a spherical aberration.

As described above, according to a preferred embodiment of the present invention, the reflective surface shape of the deformable mirror (i.e., the positions of the micromirrors) is optimized appropriately so as to minimize those aberrations. And when a lens shift is produced after that, the reflective surface shape will be adjusted finely according to the magnitude of the lens shift produced.

In the preferred embodiments described above, a deformable mirror, obtained by providing a lot of displaceable micromirrors on a substrate, is used as exemplary wavefront correcting means. Alternatively, a liquid crystal element, which can form any desired refractive index distribution on a cross section of the light beam, may also be used.

Apparatus such as an optical disc drive according to any of various preferred embodiments of the present invention described above can be used effectively and broadly in any situation where aberrations need to be corrected when some lens shift is produced.

While the present invention has been described with respect to preferred embodiments thereof, it will be apparent to those skilled in the art that the disclosed invention may be modified in numerous ways and may assume many embodiments other than those specifically described above. Accordingly, it is intended by the appended claims to cover all modifications of the invention that fall within the true spirit and scope of the invention.

This application is based on Japanese Patent Applications No. 2003-332209 filed Sep. 24, 2003 and No. 2004-272823 filed Sep. 21, 2004, the entire contents of which are hereby incorporated by reference.

1. An apparatus for reading and/or writing data from/on a medium with a light beam, the apparatus comprising:
a light source for generating the light beam;
an objective lens for focusing the light beam onto the medium;
lens shift sensing means for sensing how much the optical axis of the objective lens has shifted from that of the light beam;
wavefront correcting means, in which a plurality of correcting elements are arranged as a two-dimensional array so as to locally correct the wavefront of the light beam and to be driven independently of each other;
wavefront calculating means for finding correlation between each coordinate on a cross section of the light beam and the wavefront phase of the light beam;
lens shift correction calculating means for modifying the coordinate-wavefront phase correlation according to the output of the lens shift sensing means; and
control means for controlling the wavefront correcting means in accordance with the output of the lens shift correction calculating means.

2. The apparatus of claim 1, further comprising a wavefront sensor for sensing the wavefront of the light beam,
wherein the wavefront calculating means finds the correlation between each said coordinate on the cross section of the light beam and the wavefront phase of the light beam in accordance with the output of the wavefront sensor.

3. The apparatus of claim 1, further comprising means for sensing the tilt of the medium with respect to the light beam,
wherein the wavefront calculating means finds the correlation between each said coordinate on the cross section of the light beam and the wavefront phase of the light beam in accordance with the tilt of the medium with respect to the light beam.

4. The apparatus of claim 1, further comprising means for sensing the spherical aberration on the medium,
wherein the wavefront calculating means finds the correlation between each said coordinate on the cross section of the light beam and the wavefront phase of the light beam in accordance with the spherical aberration.

5. The apparatus of claim 1, wherein the lens shift correction calculating means modifies the coordinate-wavefront phase correlation by shifting the coordinate of the light beam in a direction in which the optical axis of the objective lens has shifted from that of the light beam.

6. The apparatus of claim 5, wherein supposing the correcting elements are arranged at a pitch p in the direction in which the optical axis of the objective lens has shifted from that of the light beam,
the lens shift correction calculating means shifts the coordinate of the light beam even if the shift of the optical axis is smaller than the pitch p.

7. The apparatus of claim 1, wherein the wavefront calculating means calculates an overall aberration as a composite of a first aberration mode, associated with a variation in the base material thickness of the medium, and a second aberration mode associated with the tilt of the medium.

8. The apparatus of claim 7, wherein the first aberration mode includes a term of the sixth or higher order within itself with respect to a distance r from the center of the optical axis.

9. The apparatus of claim 7, wherein the second aberration mode includes a term of the fifth or higher order within itself with respect to a distance r from the center of the optical axis.

10. The apparatus of claim 1, wherein each said correcting element of the wavefront correcting means includes a micro reflective mirror that reflects the light beam, and the wavefront correcting means functions as a deformable mirror.

11. The apparatus of claim 1, wherein the wavefront correcting means includes liquid crystal elements, and each said correcting element of the wavefront correcting means has a liquid crystal region for optically modulating the light beam.

12. An optical pickup comprising:
a base;
a light source, which is provided on the base so as to emit a light beam;
an objective lens, which is provided on the base in rotatable position so as to focus the light beam onto a medium;
an objective lens actuator, which is able to move the objective lens perpendicularly to the optical axis of the light beam; and
wavefront correcting means, which is provided on the base such that a plurality of correcting elements, each correcting the wavefront of the light beam locally, are arranged as a two-dimensional array, and which defines a spatial wavefront correction pattern by controlling these correcting elements independently of each other,
wherein the optical pickup shifts the wavefront correction pattern, defined by the wavefront correcting means, in a direction in which the optical axis of the objective lens has shifted from that of the light beam.
